(19) United States
(12) Patent Application Publication
(10) Pub. No.: US 2026/0057155 A1
(43) Pub. Date: Feb. 26, 2026

(54) METHOD FOR IDENTIFYING PIPELINE SEGMENTS WITH HIGH LIKELIHOOD OF INTERNAL CORROSION FAILURE

(71) Applicants: SouthWest Petroleum University, Chengdu (CN); Gas Transmission Management Department, Southwest Oil & Gas Field Company, Petrochina, Chengdu (CN)

(72) Inventors: Min QIN, Chengdu (CN); Xueling WU, Chengdu (CN); Shijian ZHANG, Chengdu (CN); Kexi LIAO, Chengdu (CN); Guoxi HE, Chengdu (CN); Tengjiao HE, Chengdu (CN)

(73) Assignees: SouthWest Petroleum University, Chengdu (CN); Gas Transmission Management Department, Southwest Oil & Gas Field Company, Petrochina, Chengdu (CN)

(21) Appl. No.: 19/372,214

(22) Filed: Oct. 28, 2025

(51) Int. Cl. G06F 30/28; G06F 113/14

(52) U.S. Cl. CPC G06F 30/28; G06F 2113/14

(57) ABSTRACT

The present disclosure discloses a method for identifying the pipeline section with a high likelihood of internal corrosion failure. Through the three-dimensional multiphase flow simulation calculation of natural gas gathering and transportation pipeline, the flow parameters along the pipeline are obtained, and the data are collected; combined with the multiphase flow simulation parameters and data, the internal corrosion mechanism of the pipeline is clarified, the influencing factors of internal corrosion are identified, and the local corrosion rate along the pipeline is predicted by combining various corrosion influencing factors. Finally, the local corrosion failure criterion CRT is established, and the likelihood level of the internal corrosion failure is determined, which can be used to identify the high corrosion failure likelihood pipeline section of the natural gas gathering and transportation pipeline.

### TECHNICAL FIELD

The present disclosure relates to a method for identifying pipeline segments with a high likelihood of internal corrosion failure, which is mainly used for the identification of failure-prone pipe sections with internal corrosion of natural gas gathering and transportation pipelines, and relates to the technical field of safety risk assessment of natural gas pipelines.

### BACKGROUND

Natural gas gathering and transportation pipelines in China operate with complex transmission media, making them susceptible to internal corrosion perforation accidents under the synergistic effect of multiple factors.

In-line inspection (ILI) is the most accurate method for assessing internal pipeline corrosion; however, its high cost limits widespread application. Consequently, in 2002, the National Association of Corrosion Engineers (NACE) introduced the Internal Corrosion Direct Assessment (ICDA) methodology. This framework includes specific standards for dry gas (DG-ICDA), liquid petroleum (LP-ICDA), wet gas (WG-ICDA), and multiphase flow (MP-ICDA) pipelines.

The ICDA process comprises four stages: pre-assessment, indirect inspection, direct examination, and post-assessment. The pre-assessment stage determines the feasibility of an ICDA study through data collection and identifies critical evaluation areas. Subsequently, indirect inspection predicts corrosion rates based on multiphase flow simulation results. Therefore, accurate corrosion rate prediction is a critical parameter for enhancing the effectiveness of ICDA. To improve pipeline integrity management and reduce the risk of corrosion failure, precise prediction of internal corrosion has become essential. Correspondingly, corrosion prediction models have evolved from empirical and semi-empirical approaches to more sophisticated mechanistic models.

However, practical challenges persist. In industrial settings, it is difficult to construct mechanistic models that accurately represent common multi-factor synergistic corrosion environments, and many empirical models are highly dependent on specific historical corrosion data, limiting their applicability, particularly for predicting flow-induced corrosion in gathering pipelines.

Current research on multi-factor synergistic corrosion in these pipelines faces several difficulties: The transmission media vary significantly between pipeline sections, requiring precise tracing of the specific media and their concentration ranges that influence corrosion; gathering pipelines, often located in mountainous terrain with significant elevation changes, are subject to complex gas-liquid flow regimes, necessitating a clearer understanding of flow-induced corrosion; the synergistic corrosion mechanisms involving CO₂, sulfate-reducing bacteria (SRB), O₂, and other factors remain inadequately understood. Thus, further research is needed to elucidate these mechanisms and develop accurate corrosion prediction models. The inability to quantify the likelihood of corrosion failure has become a bottleneck for implementing risk-based corrosion management strategies.

This study aims to address these gaps by predicting local corrosion rates along the pipeline through integrated three-dimensional multiphase flow simulations and a multi-factor synergistic corrosion model. By identifying key corrosion-influencing factors and calculating local corrosion rates, a local corrosion failure criterion CRT can be established to determine the likelihood level of internal corrosion failure. This approach provides a methodological basis for identifying pipeline segments with a high failure likelihood in natural gas gathering and transportation systems.

### SUMMARY

In order to identify the likelihood of high corrosion failure of natural gas gathering and transportation pipelines and reduce pipeline failure accidents caused by internal corrosion, the present disclosure proposes a method for identifying pipeline segments with a high likelihood of internal corrosion failure.

In order to achieve the above purpose, the present disclosure adopts the following technical scheme:
S1: Constructing a three-dimensional flow model of the pipeline, performing a multiphase flow simulation, calculating flow parameters along the pipeline, and performing a data acquisition;
S2: Clarifying a corrosion mechanism in the pipeline combined with multiphase flow simulation parameters and data;
S3: Identifying influencing factors of internal corrosion by studying the internal corrosion mechanism;
S4: Predicting the local corrosion rate along the pipeline combined with a variety of corrosion influencing factors;
S5: Constructing a local corrosion failure criterion CRT according to the obtained local corrosion rate;
S6: Determining a likelihood level of internal corrosion failure through the local corrosion failure criterion.

In some embodiments, the prediction model of the local corrosion rate along the pipeline in S4 is:

$$ln ( CR - CR ( SRB ) - CR ( {CO}_{2} ) - CR ( DO ) ) = A {ln ( v + 1 )}^{2} + B ln ( v + 1 ) + D ln ( {C}_{{CL}^{-}} + 1 ) + E$$

where CR(SRB) is a corrosion rate caused by SRB, in mm/a (millimeters/annum); CR(CO₂) is a corrosion rate caused by CO₂, in mm/a; CR (DO) is a corrosion rate caused by dissolved oxygen, in mm/a; C_{cl-} is a Cl⁻ concentration, in mg/L; A B D E are constants, which is obtained by fitting the experimental data.

In some embodiments, the CRT calculation formula of the local corrosion failure criterion in S5 is:

$$CRT = \frac{2}{3} δ / {CR}_{l}$$

where CRT is a service life of the pipeline under localized corrosion, a (years); δ is a wall thickness of the pipeline in engineering, mm; and CR_{I} is a local corrosion rate, mm/a.

In some embodiments, the likelihood of local corrosion failure is divided into five levels based on the ratio of wall thickness to corrosion rate of pipeline in engineering, among which level 1 denotes ‘very low’ failure likelihood, level 2 denotes ‘low’ failure likelihood, level 3 denotes ‘medium’ failure likelihood, level 4 denotes ‘medium-high’ failure likelihood and level 5 denotes ‘high’ corrosion failure likelihood, the identification method of local internal corrosion failure likelihood is calculated according to the following steps:
301: When CRT>20a, the failure likelihood level is judged to be 1;
302: When 20a<CRT≤10a, the failure likelihood level is judged to be 2;
303: When 10a<CRT<5a, the failure likelihood level is judged to be 3;
304: When 5a<CRT<3a, the failure likelihood level is judged to be 4;
305: When CRT<1a, the failure likelihood level is judged to be 5.

### BRIEF DESCRIPTION OF THE DRAWINGS

FIG. 1 is a flow chart for determining the likelihood of internal corrosion failure of the present disclosure.

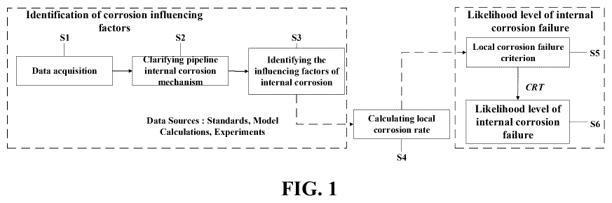

FIG. 2 is a corrosion failure likelihood level diagram of the pipeline in the present disclosure.

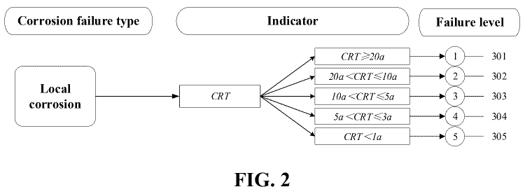

### DETAILED DESCRIPTION OF THE EMBODIMENTS

A method for identifying pipeline segments with a high likelihood of internal corrosion failure is characterized in that it includes the following steps:
S1: A three-dimensional flow model of the pipeline is constructed, a multiphase flow simulation is performed, the flow parameters along the pipeline are calculated, and the data acquisition is performed;
S2: The corrosion mechanism in the pipeline is clarified combined with multiphase flow simulation parameters and data;
S3: The influencing factors of internal corrosion are identified by studying the internal corrosion mechanism;
S4: The local corrosion rate along the pipeline is predicted combined with a variety of corrosion influencing factors;
S5: A local corrosion failure criterion CRT is constructed according to the obtained local corrosion rate;
S6: The likelihood level of internal corrosion failure is determined through the local corrosion failure criterion.

The prediction model of the local corrosion rate along the pipeline in S4 is:

$$ln ( CR - CR ( SRB ) - CR ( {CO}_{2} ) - CR ( DO ) ) = A {ln ( v + 1 )}^{2} + B ln ( v + 1 ) + D ln ( {C}_{{CL}^{-}} + 1 ) + E$$

where CR(SRB) is a corrosion rate caused by SRB, in mm/a; CR(CO₂) is a corrosion rate caused by CO₂, in mm/a; CR (DO) is a corrosion rate caused by dissolved oxygen, in mm/a; C_{cl-} is a Cl⁻ concentration, in mg/L; A B D E are constants, which is obtained by fitting the experimental data.

In some embodiments, the CRT calculation formula of the local corrosion failure criterion in S5 is:

$$CRT = \frac{2}{3} δ / {CR}_{l}$$

where CRT is a service life of the pipeline under localized corrosion, a (years);
δ is a wall thickness of pipeline in engineering, mm; and CR_{I} is a local corrosion rate, mm/a.

In some embodiments, the likelihood of local corrosion failure is divided into five levels based on the ratio of wall thickness to corrosion rate of pipeline in engineering, among which level 1 denotes ‘very low’ failure likelihood, level 2 denotes ‘low’ failure likelihood, level 3 denotes ‘medium’ failure likelihood, level 4 denotes ‘medium-high’ failure likelihood and level 5 denotes ‘high’ corrosion failure likelihood, the identification method of local internal corrosion failure likelihood is calculated according to the following steps:
301: when CRT>20a, the failure likelihood level is judged to be 1;
302: when 20a<CRT≤10a, the failure likelihood level is judged to be 2;
303: when 10a<CRT≤5a, the failure likelihood level is judged to be 3;
304: when 5a<CRT<3a, the failure likelihood level is judged to be 4;
305: when CRT<1a, the failure likelihood level is judged to be 5.

What is claimed is:

1. A method for identifying pipeline segments with a high likelihood of internal corrosion failure, comprising the following steps:
S1: constructing a three-dimensional flow model of the pipeline, performing a multiphase flow simulation, calculating flow parameters along the pipeline, and performing a data acquisition;
S2: clarifying a corrosion mechanism in the pipeline combined with multiphase flow simulation parameters and data;
S3: identifying influencing factors of internal corrosion by studying the internal corrosion mechanism;
S4: predicting the local corrosion rate along the pipeline combined with a variety of corrosion influencing factors;
S5: constructing a local corrosion failure criterion CRT according to the obtained local corrosion rate;
S6: determining a likelihood level of internal corrosion failure through the local corrosion failure criterion.

2. The method for identifying pipeline segments with a high likelihood of internal corrosion failure according to claim 1, wherein the prediction model of the local corrosion rate along the pipeline in S4 is:
$$ln ( CR - CR ( SRB ) - CR ( {CO}_{2} ) - CR ( DO ) ) = A {ln ( v + 1 )}^{2} + B ln ( v + 1 ) + D ln ( {C}_{{CL}^{-}} + 1 ) + E$$
where CR(SRB) is a corrosion rate caused by SRB, in mm/a; CR(CO₂) is a corrosion rate caused by CO₂, in mm/a; CR (DO) is a corrosion rate caused by dissolved oxygen, in mm/a; C_{cl-} is a Cl⁻ concentration, in mg/L; A B D E are constants, which is obtained by fitting the experimental data.

3. The method for identifying pipeline segments with a high likelihood of internal corrosion failure according to claim 1, wherein the CRT calculation formula of the local corrosion failure criterion in S5 is:
$$CRT = \frac{2}{3} δ / {CR}_{l}$$
where CRT is a service life of the pipeline under localized corrosion, a (years); δ is a wall thickness of pipeline in engineering, mm; and CR_{I} is a local corrosion rate, in mm/a.

4. The method for identifying pipeline segments with high likelihood of internal corrosion failure according to claim 1, wherein the likelihood of local corrosion failure is divided into five levels based on the ratio of wall thickness to corrosion rate of pipeline in engineering, among which level 1 denotes ‘very low’ failure likelihood, level 2 denotes ‘low’ failure likelihood, level 3 denotes ‘medium’ failure likelihood, level 4 denotes ‘medium-high’ failure likelihood and level 5 denotes ‘high’ corrosion failure likelihood, the identification method of local internal corrosion failure likelihood is calculated according to the following steps:
301: when CRT>20a, the failure likelihood level is judged to be 1;
302: when 20a<CRT≤10a, the failure likelihood level is judged to be 2;
303: when 10a<CRT≤5a, the failure likelihood level is judged to be 3;
304: when 5a<CRT≤3a, the failure likelihood level is judged to be 4;
305: when CRT<1a, the failure likelihood level is judged to be 5.
